(19) United States
(12) Patent Application Publication
(10) Pub. No.: US 2010/0035135 A1
(43) Pub. Date: Feb. 11, 2010

(54) PORTABLE ELECTRONIC APPARATUS

(75) Inventor: Yasushi Komine, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/406,770

(22) Filed: Mar. 18, 2009

(30) Foreign Application Priority Data
Aug. 6, 2008 (JP) 2008-203291

(51) Int. Cl. H01M 2/10

(52) U.S. Cl. 429/100

(57) ABSTRACT

A portable electronic apparatus has a housing including a connection terminal and a battery container, and has a battery lid. The connection terminal is adapted for an interface with the outside of the portable electronic apparatus. The battery lid is configured to be put on and taken off the housing. The battery lid has a connection terminal cover positioned in front of a front face of the connection terminal in a case where the battery lid is put on the housing.

### CROSS REFERENCE TO RELATED APPLICATIONS

This application is based upon and claims the benefit of priority from the prior Japanese Patent Application No. 2008-203291 filed on Aug. 6, 2008; the entire contents of which are incorporated herein by reference.

### BACKGROUND OF THE INVENTION

1. Field of the Invention

The present invention relates to a portable electronic apparatus, and in particular to a battery driven type portable electronic apparatus.

2. Description of the Related Art

A portable electronic apparatus such as a mobile phone or a digital still camera is configured to accommodate a battery and to use the battery as a power supply. The portable electronic apparatus has a housing including a battery container for accommodating the battery, and a battery lid may be put on in order to cover the battery container.

Meanwhile, the portable electronic apparatus is equipped with multiple functions within a light, thin, short and small housing these days. Thus, the battery lid can be used for parts mounting space, or space occupied by the battery lid can be saved while keeping mechanical strength, as disclosed in, e.g., Japanese Patent Publication of Unexamined Applications (Kokai), No. 2008-54113, and No. 2006-210251.

JP 2008-54113 discloses a portable electronic apparatus equipped with a radio frequency identification (RFID) function having an antenna mounted on a battery lid. The antenna is connected to a circuit mounted inside the portable electronic apparatus through a contact pin configured to be elastically connected to a terminal of the antenna.

JP 2006-210251 discloses an electronic apparatus having a battery lid unit for covering a battery container. The battery lid unit is formed by a battery lid made of plastic and a metallic first plate so as to secure an aesthetic feature and mechanical strength. The battery lid and the first plate have holes inside, and an external power supply cable may be connected to a cable terminal through the holes.

A latest portable electronic apparatus having multiple functions has connection terminals for various external interfaces, such as a connector for connecting a cable, a slot for loading a medium such as a memory card and so on. Such a connection terminal needs to be covered by a dust-proof cover while not being used.

The connection terminal cover described above of a usual portable electronic apparatus is put on its housing. In a structure where the battery lid slides along a face of the thin housing (in a direction vertical to the thickness of the housing) so as to be put on or to be taken off, however, the connection terminal cover and the battery lid may possibly mechanically interfere with each other.

In order to avoid such interference, it has been considered that a side face of the battery lid is partially removed or the housing is made thicker than a height of the connection terminal. These solutions may prevent freedom of design or slim shaping, though.

The above electronic apparatus disclosed in JP 2008-54113 or JP 2006-210251 is to address a problem related to the battery lid but of a different kind, and does not contribute to preventing the above mechanical interference while enjoying the freedom of design and slim shaping.

### SUMMARY OF THE INVENTION

Accordingly, an advantage of the present invention is to provide a portable electronic apparatus configured to prevent mechanical interference between a battery lid and a connection terminal cover while enjoying the freedom of design and slim shaping.

To achieve the above advantage, one aspect of the present invention is to provide a portable electronic apparatus having a housing including a connection terminal and a battery container, and having a battery lid. The connection terminal is adapted for an interface with the outside of the portable electronic apparatus. The battery lid is configured to be put on and taken off the housing. The battery lid has a connection terminal cover positioned in front of a front face of the connection terminal in a case where the battery lid is put on the housing.

### BRIEF DESCRIPTION OF THE DRAWINGS

FIG. 1 is an external (front) view of a mobile communication device, i.e., a portable electronic apparatus of an embodiment of the present invention.

FIG. 2 is a perspective view of the mobile communication device of the embodiment in condition that first and second sections of the mobile communication device are open to each other.

FIG. 3 is a perspective view of the second section of the embodiment in condition that a back face of the second section is directed upwards.

FIG. 4 is a perspective view of the second section of the embodiment in condition that the back face of the second section is directed upwards, and that a battery lid and a main portion of the housing are shown to be separate, upper and lower.

FIG. 5 illustrates a direction in which the battery lid of the embodiment is put on and taken off the main portion.

FIG. 6A illustrates a state of the battery lid of the embodiment moving against the main portion for putting on and taking off the main portion.

FIG. 6B illustrates a state of the battery lid of the embodiment put on the main portion.

FIG. 7A illustrates a state of a battery lid of an example to be compared with the embodiment moving against a main portion for putting on and taking off the main portion.

FIG. 7B illustrates a state of the battery lid of the example to be compared with the embodiment put on the main portion.

### DETAILED DESCRIPTION OF THE INVENTION

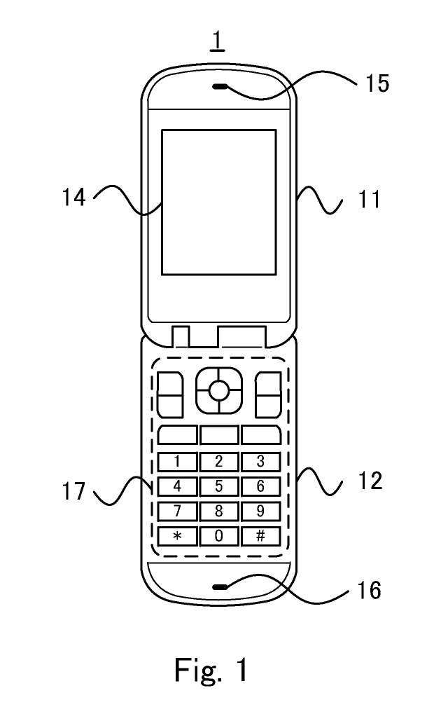

An embodiment of the present invention will be described with reference to FIGS. 1-6B. In following descriptions, terms such as upper, lower, left, right, horizontal or vertical used while referring to a drawing shall be interpreted on a page of the drawing unless otherwise noted. A same reference numeral given in no less than two drawings shall represent a same member or a same portion.

FIG. 1 is an external (front) view of a flip type mobile communication device 1, i.e., an electronic apparatus of the first embodiment. The mobile communication device 1 is constituted by a first section 11 and a second section 12 which are connected in such a way as to be open or closed to each other. FIG. 1 shows a front view of the mobile communication device 1 as viewed from a user in condition that the first section 11 and the second section 12 are open to each other. The mobile communication device 1 is not limited to the flip type shown in FIG. 1, and may have another housing structure.

The first section 11 has a display device 14 formed by, e.g., a liquid crystal device. The display device 14 is configured to display text and an image. The mobile communication device 1 is configured to perform an application accompanied by a display of a screen (e.g., sending and receiving an email, web browsing, making and using a directory, etc.) by using the display device 14. The first section 11 has an earpiece 15. The second section 12 has a microphone 16. As having the earpiece 15 and the microphone 16, the mobile communication device 1 is configured to be used for voice communication.

The second section 12 has an operation section 17 (shown as surrounded by a dashed frame) constituted by a plurality of operation keys. The operation section 17 may include an operation key that is not shown and arranged on a back or side face of the first section 11 or the second section 12. Upon one of the operation keys of the operation section 17 being operated, the mobile communication device 1 is operated so as to start or stop working, or is provided with text or an operation command. Each of the display device 14, the earpiece 15, the microphone 16 and the operation section 17 is configured to work as a user interface of the mobile communication device 1.

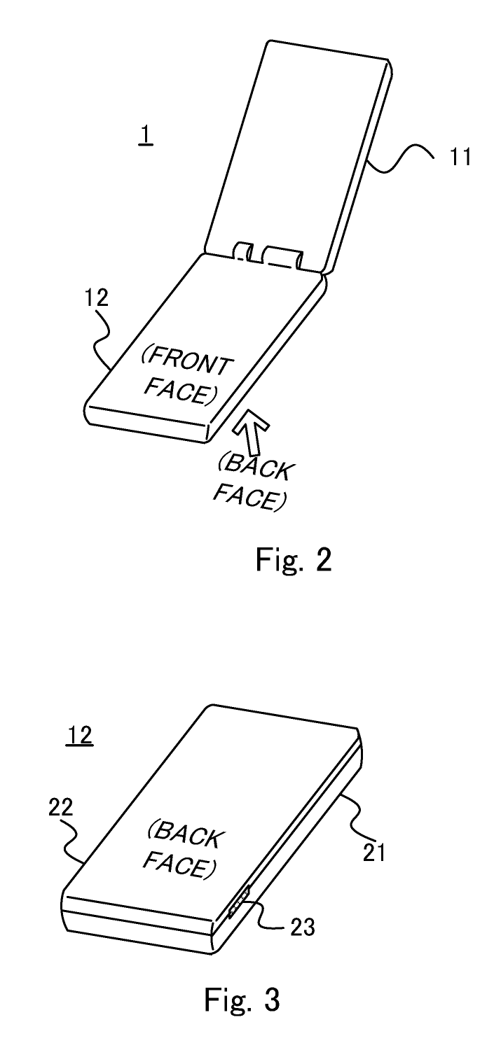

FIG. 2 is a perspective view of the mobile communication device 1 as viewed from a little right hand side of a front direction in condition that the first section 11 and the second section 12 are open to each other. Portions other than the first section 11 and the second section 12 are not shown in FIG. 2. An upper face of the second section 12 shown in FIG. 2 is called a front face, and a back side of the front face that is not shown is called a back face.

FIG. 3 is a perspective view of the second section 12 in condition that the back face is directed upwards. The second section 12 has a main portion 21 and a battery lid 22. The main portion 21 may be divided into a front side case and a back side case which are not shown. The battery lid 22 has a connection terminal cover 23 indicated by hatching.

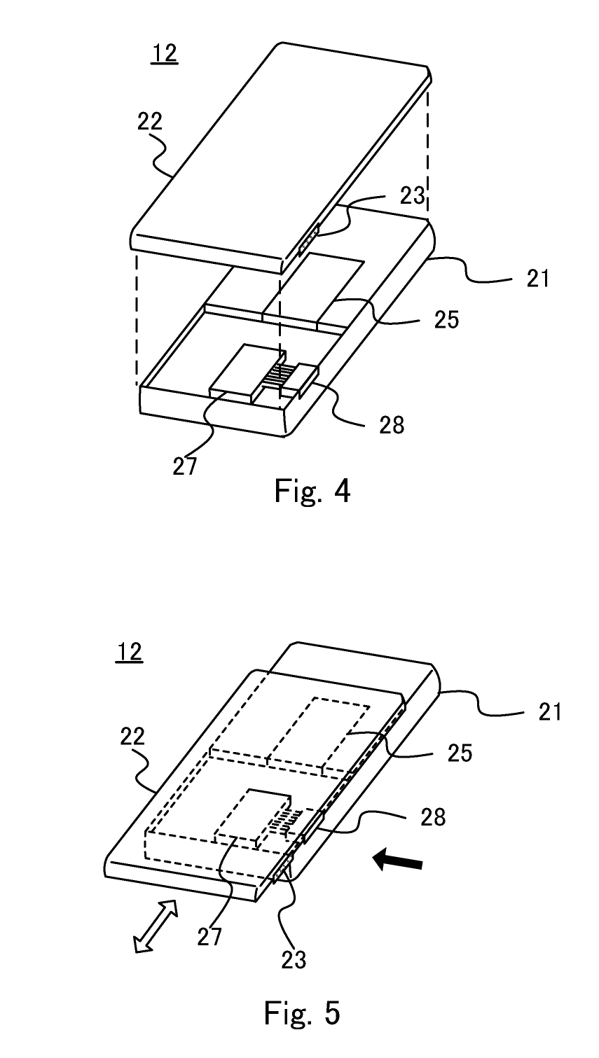

FIG. 4 is a perspective view of the second section 12 in condition that the back face is directed upwards similarly as in FIG. 3, and that the battery lid 22 and the main portion 21 are shown to be separate, upper and lower (which does not mean that the battery lid 22 is put on and taken off the main portion 21 by moving upwards and downwards). The battery lid 22 is formed in such a way as to cover almost the whole main portion 21 while being put on the main portion 21, as viewed in a direction of a thickness of the main portion 21 (i.e., from upper to lower in FIG. 4).

The main portion 21 includes a battery container 25, and is so configured that a battery may be put on and taken off after the battery lid 22 is taken off the main portion 21. The main portion 21 has a circuit portion 27 and a connector 28 for connecting a cable. A cable that is not shown can be connected to the connector 28 so that the circuit portion 27 can be connected to an external apparatus that is not shown.

The connection terminal cover 23 is arranged at a position in front of the connector 28 if the battery lid 22 is put on the main portion 21. Thus, the connection terminal cover 23 may cover a front face of the connector 28 if the battery lid 22 is put on the main portion 21. The main portion 21 and the battery lid 22 are so configured that the connection cover 23 covers a slot which is included in the main portion 21 and into which a medium such as a memory card can be loaded.

FIG. 5 illustrates a direction in which the battery lid 22 is put on and taken off the main portion 21. The battery lid 22 is configured to be put on and taken off in such a direction as to slide along a face of the main portion 21 on its back side (indicated by a white block arrow in FIG. 5). Each of portions shown in FIG. 5 which is a same as the corresponding one shown in FIG. 4 is given a same reference numeral, and its explanation is omitted.

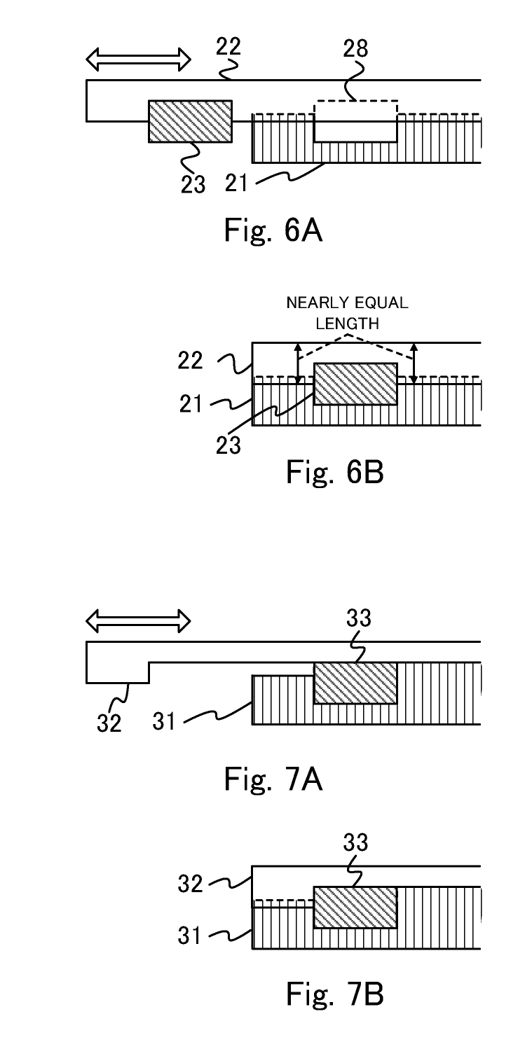

FIG. 6A illustrates a state of the battery lid 22 moving against the main portion 21 for putting on and taking off the main portion 21 as viewed in a direction indicated by a black-colored block arrow shown in FIG. 5. Each of portions shown in FIG. 6A which is a same as the corresponding one shown in FIG. 4 is given a same reference numeral, and its explanation is omitted. In FIG. 6A, a direction of putting on and taking off described above is indicated by a white-colored block arrow. The connection cover terminal 23 is formed by, e.g., elastic material, and an upper side portion of its outline is supposed to be fixed to the battery lid 22.

If the battery lid 22 slides rightwards in FIG. 6A, a right side portion of the connection terminal cover 23 looks like hitting a left side of a front face of the connector 28. As the battery lid 22 and the connection terminal cover 23 is positioned further forward (in FIG. 6A, on the front side of the page) than the front face of the connector 28, though, the connection terminal cover 23 does not cause significant mechanical interference with the connector 28. Even if the connection terminal cover 23 and the connector 28 cause a little mechanical interference, that does not cause a problem if a lower side portion of the connection terminal cover 23 is configured to be lifted, in FIG. 6A, forward of the page.

FIG. 6B illustrates a state of the battery lid 22 put on the main portion 21 as viewed in the same direction as in FIG. 6A. Each of portions shown in FIG. 6B is a same as the corresponding one shown in FIG. 6A.

As the mechanical interference between the connection terminal cover 23 and the connector 28 does not cause a problem as described with reference to FIG. 6A, the battery lid 22 may be shaped to have nearly equal lengths on both sides of the connection terminal cover 23 in a direction of the thickness of the main portion 21 (i.e., the direction of the housing thickness of the mobile communication device 1, the top-to-bottom direction in FIGS. 6A and 6B) as viewed from the exact front of the connector 28 (i.e., in the direction vertical to the page in FIG. 6B). As a result, in a case where, e.g., the battery lid 22 and the main portion 21 are painted with different colors, a left-to-right straight separate line may be drawn in FIG. 6A or 6B.

FIG. 7A illustrates, so as to be compared with FIG. 6A, a state of the battery lid putting on and taking off the main portion in a case where the main portion has the connection terminal cover. Each of portions given reference numerals 31, 32 and 33 in FIG. 7 corresponds to the main portion 21, the battery lid 22 and the connection terminal cover 23 shown in FIG. 6A, respectively.

FIG. 7B illustrates a state of the battery lid 32 put on the main portion 31 as viewed in the same direction as in FIG. 7A. Each of portions shown in FIG. 7B is a same as the corresponding one shown in FIG. 7A. The connection terminal cover 33 covers a front face of a connector arranged in the main portion 31 but is not shown.

As shown in FIG. 7A, a size of the battery lid 32 in a direction of a housing thickness (a top-to-bottom direction in FIGS. 7A-7B) decreases at an inside portion next to a left end portion, and then levels off in a rightward direction. In this way, while sliding rightwards in FIG. 7A, the battery lid 32 may avoid mechanical interference with the connection terminal cover 33 positioned, similarly to the battery lid 32, further forward (in FIG. 7A, on the front side of the page) than a front face of the connector that is not shown.

As a result, as shown in FIG. 7B though, the battery lid 32 cannot be shaped to have nearly equal lengths on both sides of the connection terminal cover 33 in a direction of the thickness of the main portion 31 (i.e., the top-to-bottom direction in FIGS. 7A and 7B) as viewed from the exact front of the connector that is not shown (i.e., in the direction vertical to the page in FIG. 7B).

Another method for avoiding the interference is to shift the position of the connection terminal cover 33 (i.e., of the connector that is not shown) downwards in FIG. 7A. The method cannot be taken though without an enough thickness of the main portion 31, and consequently runs counter to slim shaping of the mobile communication device.

As shown in FIG. 7B, the length of the main portion 31 in the thickness direction (top-to-bottom direction) has a difference in level on both sides of the connection terminal cover 33. Thus, in a case where the battery lid 32 and the main portion 31 are painted with different colors, a left-to-right straight separate line cannot be drawn (the main portion 31 should be painted separately with plural colors to draw a straight separate line, instead).

As shown in FIGS. 6A, 6B and FIGS. 7A, 7B being compared with each other, the battery lid 22 has the connection terminal cover 23 so that the size of the battery lid 22 is made equal on both sides of the connection terminal cover 23. Thus, a degree of design freedom such as coloring increases without making the housing of the mobile communication terminal 1 excessively thick.

According to the embodiment of the present invention described above, the portable electronic apparatus can prevent the mechanical interference between the battery lid and the connection terminal cover while enjoying the freedom of design and slim shaping.

In the above description of the embodiments, the external view, the shape, the configuration, the connections, the screen displays, the logical processes, the way of putting the battery lid on and so on are considered as exemplary only, and thus may be variously modified within the scope of the present invention.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A portable electronic apparatus, comprising:
a housing including a connection terminal and a battery container, the connection terminal adapted for an interface with the outside of the portable electronic apparatus; and
a battery lid configured to be put on and taken off the housing, the battery lid having a connection terminal cover positioned in front of a front face of the connection terminal in a case where the battery lid is put on the housing.

2. The portable electronic apparatus of claim 1, wherein the battery lid has a first portion on one side of the connection terminal and a second portion on an opposite side of the connection terminal, the second portion being as long as the first portion in a direction of a thickness of the housing as viewed from a front of the connection terminal.

3. The portable electronic apparatus of claim 1, wherein the battery lid is configured to cover a whole face of the housing as viewed in the direction of the thickness of the housing.

4. The portable electronic apparatus of claim 1, wherein the connection terminal is a connector for connecting a cable.

5. The portable electronic apparatus of claim 1, wherein the connection terminal is a slot into which a medium can be loaded.
